(19) United States
(12) Patent Application Publication
(10) Pub. No.: US 2015/0039291 A1
(43) Pub. Date: Feb. 5, 2015

(54) Using a group of CVs and Job Descriptions in a database to establish a library of contextual words and phrases against which documents (CVs or Job Descriptions) can be matched, scored, and ranked.

(71) Applicant: Anthony Au, Vancouver (CA)

(72) Inventor: Anthony Au, Vancouver (CA)

(21) Appl. No.: 13/959,638

(22) Filed: Aug. 5, 2013

(51) Int. Cl. G06F 17/27

(52) U.S. Cl. CPC G06F 17/2705
USPC 704/9

(57) ABSTRACT

The present invention relates to using a group of CVs and Job Descriptions (Documents) in a database to establish a library of contextual phrases (References), against which Documents (internal in the database, and external from the database) can be matched, scored, and ranked.

### CROSS-REFERENCES TO RELATED APPLICATIONS (IF ANY)

None

### BACKGROUND

1. Field of the Invention

The present invention relates to a data processing system that uses a group of CVs and Job Descriptions in a database to establish a library of contextual words and phrases against which documents (CVs and Job Descriptions) can be matched, scored, and ranked.

2. Description of Prior Art

Traditionally, recruiting requires constant interaction by individuals on both sides of the meeting table. This dynamic (human) interaction is of particular importance for senior management positions, say, at top levels of an organization and their first-line reports, where the matching process is often based on intangible, unique (to a particular management situation) and variable factors.

At the most senior management levels, recruitment will likely continue to be conducted with an evaluation process that revolves around constant interaction, based on real time interface between two parties.

But apart from the senior levels, recruitment of middle management and general staff positions, given their more prevalent responsibilities, are more reliant on common and standard data, through a matching process that requires less real time interaction. Recruitment at these levels are hence, more susceptible to automation.

To-date, automation on recruitment is predominantly represented by a passive display of static information on electronic poster boards similar in format and process to an electronic newspaper. The application of keyword searches is limited to a one-dimensional directory of data reference. Little value-add applications to the recruitment process are available in the recruiting automation services offered in the market today.

In addition, recruitment systems today often are matching ‘apples’ to ‘oranges’, due to the inconsistency of information supplied in the resumes of candidates and those requested in position specifications of hiring companies.

Until more relevant and consistent information can be captured, automated systems for recruitment will be confined to a simple display of limited, lower level positions, where relatively simple requirements can be standardized in a compatible format between the two parties involved in the recruitment process.

### PRIOR ART

U.S. Pat. No. 6,754,874 by Richman and issued on Jun. 22, 2004, is for a computer-aided system and method for evaluating employees. It discloses a computer-aided method of evaluating personnel performance. The method includes the steps of making available to a user an electronic evaluation form, inputting a first set of data into the electronic form corresponding to the user, submitting the form including the first set of data for review to a second user and inputting a second set of data into the electronic form corresponding to the second user.

U.S. Pat. No. 6,662,194 by Joao and issued on Dec. 9, 2003, is for an apparatus and method for providing recruitment information. It discloses an apparatus and method for providing recruitment information, including a memory device for storing information regarding at least one of a job opening, a position, an assignment, a contract, and a project, and information regarding a job search request, a processing device for processing information regarding the job search request upon a detection of an occurrence of a searching event, wherein the processing device utilizes information regarding the at least one of a job opening, a position, an assignment, a contract, and a project, stored in the memory device, and further wherein the processing device generates a message containing information regarding at least one of a job opening, a position, an assignment, a contract, and a project, wherein the message is responsive to the job search request, and a transmitter for transmitting the message to a communication device associated with an individual in real-time.

U.S. Pat. No. 6,615,182 by Powers, et al. and issued on Sep. 2, 2003, is for a system and method for defining the organizational structure of an enterprise in a performance evaluation system. It discloses an organizational structure of an enterprise is defined in a performance evaluation system by storing a plurality of user-defined levels. A user-defined hierarchy is stored for the levels.

U.S. Pat. No. 6,385,620 by Kurzius, et al. and issued on May 7, 2002, is for a system and method for the management of candidate recruiting information. It discloses a system for automated candidate recruiting using a network includes a candidate web engine operable to communicate with the network and to present a candidate survey form to a client of the network, the candidate web engine further operable to receive candidate qualification data from the client that is entered in the form.

U.S. Pat. No. 6,381,592 by Reuning and issued on Apr. 30, 2002, is for a candidate chaser. It discloses a machine and method that automatically locate Internet site pages and web postings which contain operator specified keywords or Boolean combinations and then extracts all electronic mail addresses from those pages as well as hyper-linked pages to as many linking levels as selected by the operator and then sends a job opportunity description in the form of an electronic mail message to each of the extracted addresses then receives responses from recipients of the job opportunity message then filters those messages by reading their text and forwards only desired responses to the candidate seeking client's electronic mail address thusly sparing the client interaction with large amounts of irrelevant response while presenting viable candidates for a given job opening.

U.S. Pat. No. 6,370,510 by McGovern, et al. and issued on Apr. 9, 2002, is for an employment recruiting system and method using a computer network for posting job openings and which provides for automatic periodic searching of the posted job openings. It discloses a method and apparatus for providing an interactive computer-driven employment recruiting service. The method and apparatus enables an employer to advertise available positions on the Internet, directly receive resumes from prospective candidates, and efficiently organize and screen the received resumes.

U.S. Pat. No. 6,363,376 by Wiens, et al. and issued on Mar. 26, 2002, is for a method and system for querying and posting to multiple career websites on the internet from a single interface. It discloses a method and system for querying multiple career websites from a single interface is disclosed, where each of the websites comprises a plurality of web pages having site-specific fields requiring input of data. The method and system include collecting information from a user, and mapping the user information to the site-specific fields of each of the career websites.

U.S. Pat. No. 5,991,595 by Romano, et al. and issued on Nov. 23, 1999, is for a computerized system for scoring constructed responses and methods for training, monitoring, and evaluating human rater's scoring of constructed responses. It discloses systems and methods for presentation to raters of constructed responses to test questions in electronic workfolders.

U.S. Pat. No. 5,978,768 by McGovern, et al. and issued on Nov. 2, 1999, is for a computerized job search system and method for posting and searching job openings via a computer network. It discloses a method and apparatus for providing an interactive computer-driven employment recruiting service. The method and apparatus enables an employer to advertise available positions on the Internet, directly receive resumes from prospective candidates, and efficiently organize and screen the received resumes.

U.S. Pat. No. 5,884,270 by Walker, et al. and issued on Mar. 16, 1999, is for a method and system for facilitating an employment search incorporating user-controlled anonymous communications. It discloses a system for facilitating employment searches using anonymous communications includes a plurality of party terminals, a plurality of requestor terminals, and a central controller.

U.S. Pat. No. 5,758,324 by Hartman, et al. and issued on May 26, 1998, is for a resume storage and retrieval system. It discloses a method of and apparatus for storage and retrieval of resume images in a manner which preserves the appearance, organization, and information content of the original document. In addition, summaries or “outlines” of resume images, broken down into multiple fields, are stored, and can be searched field by field.

U.S. Pat. No. 5,671,409 by Fatseas, et al. and issued on Sep. 23, 1997, is for a computer-aided interactive career search system. It discloses a method for accessing career information located in a computer database through interactive CD-ROM technology or other suitable computer-accessible means. The method involves the use of several levels of inquiry from which a user can select various careers, and for each career ask specific questions.

U.S. Pat. No. 5,164,897 by Clark, et al. and issued on Nov. 17, 1992, is for an automated method for selecting personnel matched to job criteria. It discloses an automated method for selecting personnel which includes the step of selecting a first set of employees having qualifications matching a first job criterion from a first data file where the first data file includes a first plurality of records and each record includes a first job selection criterion, such as job titles, and a corresponding employee code. A second step comprises selecting a second plurality of employees having qualifications matching a second job criteria from a second data file which includes a second plurality of records wherein each record includes a second job selection criteria, such as industrial experience, and a corresponding employee code.

The need for a better method for recruiting personnel in a manner that gives good matches to a company shows that there is still room for improvement within the art.

1. Field of the Invention

2. Description of Related Art Including Information Disclosed Under 37 CFR §1.97** > and 1.98<.

### SUMMARY OF THE INVENTION

The present invention relates to a data processing system that automatically creates a reference database with commonly found words and phrases from a group of documents (CVs and/or Job Descriptions), automatically assigns weights to each word and phrase identified, based on their frequency of occurrence, and apply both (key words & phrases) as context in the automatic matching with another document, such as a resume, to produce a numerically scored result.

The invention will reduce a substantial amount of time of conventional methods of matching candidates in recruitment, while increasing the accuracy in matching candidates with positions, at a fraction of the cost currently incurred by companies today.

The process is more efficient, effective, accurate and functional than the current art.

### GLOSSARY OF TERMS

Browser: a software program that runs on a client host and is used to request Web pages and other data from server hosts. This data can be downloaded to the client's disk or displayed on the screen by the browser.

Client host: a computer that requests Web pages from server hosts, and generally communicates through a browser program.

Content provider: a person responsible for providing the information that makes up a collection of Web pages.

Embedded client software programs: software programs that comprise part of a Web site and that get downloaded into, and executed by, the browser.

Cookies: data blocks that are transmitted to a client browser by a web site.

Hit: the event of a browser requesting a single Web component.

Host: a computer that is connected to a network such as the Internet. Every host has a hostname (e.g., mypc.mycompany.com) and a numeric IP address (e.g., 123.104.35.12).

HTML (HyperText Markup Language): the language used to author Web Pages. In its raw form, HTML looks like normal text, interspersed with formatting commands. A browser's primary function is to read and render HTML.

HTTP (HyperText Transfer Protocol): protocol used between a browser and a Web server to exchange Web pages and other data over the Internet.

HyperText: text annotated with links to other Web pages (e.g., HTML).

IP (Internet Protocol): the communication protocol governing the Internet.

Server host: a computer on the Internet that hands out Web pages through a Web server program.

URL (Uniform Resource Locator): the address of a Web component or other data. The URL identifies the protocol used to communicate with the server host, the IP address of the server host, and the location of the requested data on the server host. For example, “http://www.lucent.com/work.html” specifies an HTTP connection with the server host www.lucent.com, from which is requested the Web page (HTML file) work.html.

UWU server: in connection with the present invention, a special Web server in charge of distributing statistics describing Web traffic.

Visit: a series of requests to a fixed Web server by a single person (through a browser), occurring contiguously in time.

Web master: the (typically, technically trained) person in charge of keeping a host server and Web server program running.

Web page: multimedia information on a Web site. A Web page is typically an HTML document comprising other Web components, such as images.

Web server: a software program running on a server host, for handing out Web pages.

Web site: a collection of Web pages residing on one or multiple server hosts and accessible through the same hostname (such as, for example, www.lucent.com).

### BRIEF DESCRIPTION OF THE DRAWINGS

Without restricting the full scope of this invention, the preferred form of this invention is illustrated in the following drawings:

FIG. 1 shows an overview of how a User accesses the system.

### DESCRIPTION OF THE PREFERRED EMBODIMENT

There are a number of significant design features and improvements incorporated within the invention.

The present invention relates to a data processing system 1, which uses a group of CVs and/or Job Descriptions in a database to establish a library of contextual phrases against which documents (CVs or Job Descriptions) can be matched, scored, and ranked. This system 1 may:
Assess how well (in terms of relevance) a document (CV or Job Description) is prepared, by comparing against commonly used phrases in a database of similar job domain.
Reduce the time required to select a meaningful shortlist, as well as improving the accuracy of comparing the qualifications of candidates towards the requirements of a position. In doing so, the savings may result in reduction of both tangible and intangible costs currently incurred by an employer-company today.

The system 1 is set to run a on a computing device 10. A computing device on which the present invention can run would be comprised of a CPU, Hard Disk Drive, Keyboard, Monitor, CPU Main Memory and a portion of main memory where the system resides and executes. A printer can also be included. Any general purpose computer with an appropriate amount of storage space is suitable for this purpose. Computer Devices like this are well known in the art and are not pertinent to the invention. The system can also be written in a number of different languages and run on a number of different operating systems and platforms. The system is network based and works on an Internet, Intranet and/or Wireless network basis as well as a standalone system.

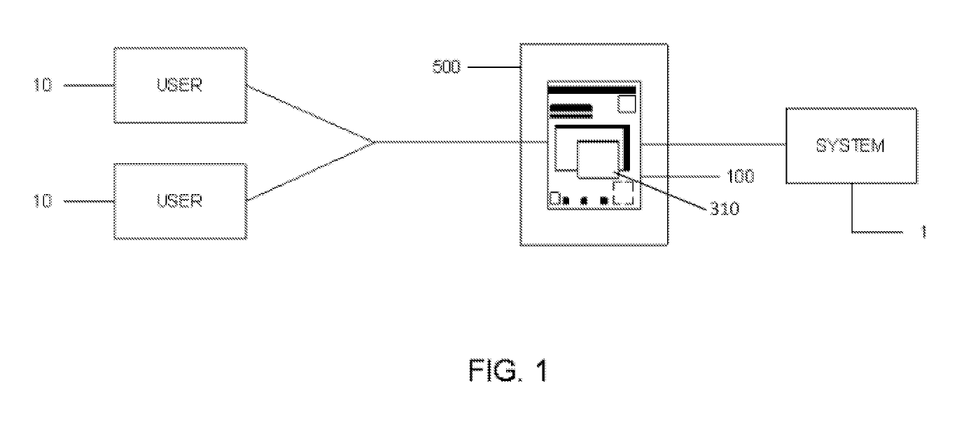

As shown in FIG. 1, the users 10 would access the system 1 through a network 100 or Internet 500. The system's software would reside in the system's memory 310. There are a number of different components of the system 1, these are described below.

The system 1 uses a memory means such as a standard hard drive or any other standard data storage device to store the data. The databases are stored in this memory and the system 1 changes the system's memory 310 as it processes.

The system 1 is a system that it uses Using a group of CVs and Job Descriptions in a database to establish a library of contextual against which can be matched, scored, and ranked.

The invention comprises the following, 2 functions:

The Extraction of commonly used contextual phrases from a group of CVs and/or Job Descriptions (Documents) in a database to create a Key Texts Library (KTL) from the same database; and

The Allocation of weights and identification to contextual phrases in the KTL.

The system 1 is designed to produce the following, 3 rankings:

The Match, score and rank each CV in a database against the KTL;

The Match, score and rank a group of CVs against a specific set of job descriptions (Job Spec); and

The Match and score a specific Job Spec against the KTL.

2 Functions of the System 1

The system 1 will extract commonly used contextual phrases from a group of CVs and/or Job Descriptions (Documents) in a database to create a Key Texts Library (KTL) from the same database.

It begins with the collection and storage in computer a group of Documents, or access a group of Documents already stored in the memory. Documents are then categorized by Industry+Job Functions (e.g. Garment+Accounting), against 2 reference lists of Industries & Job Functions.

The system 1 parses each Document to delete ‘noise’ characters & words (by pre-defined list) and define nouns & verbs (by dictionary).

The system identifies contextual phrases of parsed Documents, by reading each

Document in sequence, as follows:

Identify 1st verb and 1st noun, e.g. (1st verb) . . . (1st noun) . . . (2nd verb) . . . ;

When 2nd verb is found, check as follows:

a. If 2nd verb is also a noun, keep 2nd verb in the phrase with 1st verb and 1st noun. Continue to find 3rd verb, and repeat checking whether 3rd verb is noun to include in phrase.

b. If 2nd or 3rd verb is not a noun, include all previous noun(s) and verb(s) to set up as 1st contextual phrase.

The system 1 will then continue with rest of texts from 2nd or 3rd verb (which is not a noun) onwards, and repeat checking process in 1.4.1 and 1.4.2 above to create 2nd, and additional contextual phrases, until all texts in Document are read.

The system 1 aggregates all contextual phrases identified to create KTL.

The system 1 then updates KTL by repeating steps the previous steps to identify additional contextual phrases from each new Document added to the KTL.

This allows the KTL to be continuously enriched with additional contextual phrases from additional Documents. The KTL is deemed to be “saturated” when additional Documents entered do not produce additional contextual phrases.

The system 1 will allocate weights and identification to contextual phrases in the KTL.

The system 1 assigns a weight to each contextual phrase in KTL by:

The number of occurrence of each contextual phrase, divided by total # of contextual phrases in KTL identified at any given point in time. The highest occurrence will be assigned the highest weight.

When additional contextual phrases are added to the KTL as above, weights are re-calculated and re-assigned to each contextual phrase, according to revised frequency of occurrence.

The system 1 assigns a hex number to each contextual phrase identified with hex numbers assigned uniquely to each contextual phrase.

3 Rankings of the System 1

The system 1 will match and score each CV in same database against the KTL.

This is done by parsing each CV in the database to identify contextual phrases, per steps above. Then match each contextual phrase identified from each CV with contextual phrases in KTL, according to the rules below:

Match of 1 word in a contextual phrase is not accepted;

Contextual phrases of 2-3 words require 100% match; and

the contextual phrases of 4-10 words require a minimum of 50% match.

The system 1 allocates the weights of contextual phrases in KTL to matching contextual phrases in the CV, according to the rules below:

0 weight for matching single word; and

100% of weight for matching phrases of 2-3 words;

the weights for matching phrases of 4-10 words are calculated according to % of words matched, e.g. 75% match of words will receive 75% of weight of contextual phrase in the KTL.

The system 1 then accumulates all weighs of matching contextual phrases to produce ‘score’ of each CV. It ranks all CVs in database according to score of each CV.

With this system, it can offer a candidate an effective tool to compare his/her CV with words and phrases commonly used in the market for similar job domains, in order to increase the chances of a successful job application.

The system 1 will match, score and rank a group of CVs against a specific set of job descriptions (Job Spec).

The Recruiter supplies a specific Job Spec, categorized by Industry+Job Function (e.g. Garment+Accounting), against 2 reference lists of Industries & Job Functions. The system 1 parses the Job Spec to delete ‘noise’ characters & words (by pre-defined list) and define nouns & verbs (by dictionary).

The system 1 parses the Job Spec to identify contextual phrases, per steps above.

The system 1 assigns equal weights to each contextual phrase parsed from the Job Spec, or produces a list of contextual phrases parsed from the Job Spec for the Recruiter to assign different weights to each contextual phrase, according to the importance of each criteria determined by the recruiter. It parses all CVs (to be matched with the Job Spec) to identify contextual phrases, per steps in above.

The system 1 will match each contextual phrase from the Job Spec with contextual phrases in all CVs, according to the rules below:

Match of 1 word is not accepted;

Contextual phrases of 2-3 words require 100% match; and

Contextual phrases of 4-10 words require a minimum of 50% match.

The weights of contextual phrases from the Job Spec are allocated to matching contextual phrases of all CVs, according to the rules below:

0 weight for matching single word;

100% of weight for matching phrases of 2-3 words; and

the weights for matching phrases of 4-10 words are calculated according to % of words matched, e.g. 75% match of words will receive 75% of weight of contextual phrase in the CV.

The system 1 will then accumulate all weighs of matching contextual phrases to produce ‘score’ of each CV. It will rank each CV against the Job Spec according to scores produced.

With this system, it will provide the recruiter an automated and accurate match of any number of job applicants with specific job requirements of each specific set of job specifications.

The system 1 will match and score a specific Job Spec against the KTL.

The Recruiter supplies a specific Job Spec, categorized by Industry+Job Function (e.g. Garment+Accounting), against 2 reference lists of Industries & Job Functions. The system 1 parses the Job Spec to:

Delete ‘noise’ characters & words (by pre-defined list); and

Define nouns & verbs (by dictionary).

The system 1 parses the Job Spec to identify contextual phrases, per steps above.

The system 1 will match each contextual phrase identified from the Job Spec with contextual phrases in KTL according to the rules below:

Match of 1 word is not accepted;

Contextual phrases of 2-3 words require 100% match; and

Contextual phrases of 4-10 words require a minimum of 50% match.

The weights of contextual phrases in KTL are allocated to matching contextual phrases in the Job Spec, according to the rules below:

0 weight for matching single word;

100% of weight for matching phrases of 2-3 words; and

the weights for matching phrases of 4-10 words are calculated according to % of words matched, e.g. 75% match of words will receive 75% of weight of contextual phrase in the KTL.

The system 1 will accumulate all weighs of matching contextual phrases to produce ‘score’ of the Job Spec, matched against the KTL.

The proposed weights in the steps above are considered the best mode of practice but other weights and weighting factors can be used.

With this system, it can offer a recruiter an efficient and informed method to prepare a Job Spec, by comparing with words and phrases commonly used in the market for similar job domains, in order to prepare a relevant Job Spec which will attract appropriate job applicants from the market.

### CONCLUSION

Although the present invention has been described in considerable detail with reference to certain preferred versions thereof, other versions are possible. Therefore, the point and scope of the appended claims should not be limited to the description of the preferred versions contained herein. The system is not limited to any particular programming language or computer platform.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A data processing system comprising:
extracting from contextual phrases from a group of documents in a database contained in electronic memory and processed by a processing means to create a Key Texts Library (KTL) from the same database and allocating weights and identification to contextual phrases in the Key Texts Library.

2. A system according to claim 1 where each CV is matched, scored and ranked against the KTL.

3. A system according to claim 1 where each CV is matched, scored and ranked against a specific set of job descriptions.

4. A system according to claim 1 where a job specification is matched and scored against the KTL.

5. A system according to claim 1 where said documents are CVs and/or job descriptions.

6. A system according to claim 1 where said documents are categorized by Industry and Job Functions against a plurality of lists of Industries and Job Functions.

7. A system according to claim 6 where the system 1 parses each document to delete ‘noise’ characters and words and define nouns and verbs.

8. A system according to claim 7 where the system identifies contextual phrases of parsed Documents, by reading each Document in sequence, identify 1st verb and 1st noun, when 2nd verb is found, if the 2nd verb is also a noun, keep the 2nd verb in the phrase with 1st verb and 1st noun, continue to find 3rd verb, and repeat checking whether 3rd verb is noun to include in phrase, if the 2nd or the 3rd verb is not a noun, include all previous noun(s) and verb(s) to set up as 1st contextual phrase.

8. A system according to claim 7 where the system will then continue with rest of texts from the 2nd or the 3rd verb which is not a noun, and repeat checking process to create 2nd, and additional contextual phrases, until all texts in the document are read.

9. A system according to claim 8 where the system aggregates all contextual phrases identified to create the KTL.

10. A system according to claim 9 where the system updates KTL by repeating the steps to identify additional contextual phrases from each new document added to the KTL.

11. A system according to claim 9 where the KTL is deemed to be “saturated” when additional Documents entered do not produce additional contextual phrases.

12. A system according to claim 1 where the system will allocate weights and identification to contextual phrases in the KTL.

13. A system according to claim 1 where the system assigns a weight to each contextual phrase in KTL by the number of occurrence of each contextual phrase, divided by total number of contextual phrases in KTL identified at any given point in time with the highest occurrence assigned the highest weight.

14. A system according to claim 12 where when additional contextual phrases are added to the KTL the weights are re-calculated and re-assigned to each contextual phrase according to revised frequency of occurrence.

15. A system according to claim 13 where when additional contextual phrases are added to the KTL the weights are re-calculated and re-assigned to each contextual phrase according to revised frequency of occurrence.

16. A system according to claim 13 where the system assigns hex numbers assigned uniquely to each contextual phrase.

17. A system according to claim 1 where the system will match and score each CV in same database against the KTL by parsing each CV in the database to identify contextual phrases, then match each contextual phrase identified from each CV with contextual phrases in KTL, by matching of one word in a contextual phrase is not accepted, contextual phrases of 2-3 words require 100% match, and the contextual phrases of 4-10 words require a minimum of 50% match.

18. A system according to claim 17 where the system allocates the weights of contextual phrases in KTL to matching contextual phrases in the CV, according to the rules of zero weight for matching single word and 100% of weight for matching phrases of 2-3 words; where the weights for matching phrases of 4-10 words are calculated according to percentage of words matched, where the system then accumulates all weighs of matching contextual phrases to produce ‘score’ of each CV.

19. A system according to claim 1 where the system will match and score a specific Job Spec against the KTL where a Recruiter supplies a specific Job Spec, categorized by Industry and Job Function against two reference lists of Industries & Job Functions.

20. A system according to claim 1 where the system parses the Job Spec to delete ‘noise’ characters and words and define nouns and verbs , where the system parses the Job Spec to identify contextual phrases by matching each contextual phrase identified from the Job Spec with contextual phrases in KTL where the match of one word is not accepted, where contextual phrases of 2-3 words require 100% match; and where contextual phrases of 4-10 words require a minimum of 50% match, where the weights of contextual phrases in KTL are allocated to matching contextual phrases in the Job Spec with zero weight for matching single word, 100% of weight for matching phrases of 2-3 words; and the weights for matching phrases of 4-10 words are calculated according to percentage of words matched, and the system will accumulate all weighs of matching contextual phrases to produce ‘score’ of the Job Spec, matched against the KTL.
